(19) United States
(12) Patent Application Publication
(10) Pub. No.: US 2009/0250995 A1
(43) Pub. Date: Oct. 8, 2009

(54) Composite Carbon Fiber Wheel Rim and Method of Making Thereof

(76) Inventor: Carlos Tsai, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/098,485

(22) Filed: Apr. 7, 2008

(51) Int. Cl. B60B 21/00

(52) U.S. Cl. 301/95.108; 301/95.102

(57) ABSTRACT

A composite carbon fiber wheel rim of a tubular type comprises a friction-resisting rim body having an inner and outer circumferential periphery, and an inner rim body being disposed along the inner circumferential periphery of the friction-resisting rim body. A method for making such a wheel rim comprises forming a friction-resisting rim body, mounting inner rim body to the friction-resisting rim body, and making the friction-resisting rim body and the inner rim bodies as an integral piece. A composite carbon fiber wheel rim of a clincher type further comprises an outer rim disposed along the outer circumferential periphery. Accordingly, the outer rim is mounted to the friction-resisting rim body while mounting the inner rim.

### BACKGROUND OF THE INVENTION

1. Field of the Invention

The present invention relates to a wheel rim and its method of manufacture, in particular, to a composite carbon fiber wheel rim.

2. Description of the Related Art

The advantages of composite carbon fibers, such as inherent lightness, high material strength and stiffness, are step-by-step exploited and marketed for bikes. At first, composite carbon fiber front fork and rear stays are the tryouts in the market; and as the skill and the market become more matured, composite carbon fiber crank, seat post and handle bar are introduced. Right now, a composite carbon fiber frame is also possible and prevailed in the market.

With a whole bicycle being almost made of composite carbon fibers, the makers are now striving to develop a composite carbon fiber made wheel rim as a last goal. As an example, a section of a known clincher type composite carbon fiber wheel rim 40 is shown in FIG. 9. The wheel rim 40 includes layers of carbon fiber 41, with each layer 41 being stacked with one another in accordance with Y-axis by adhesive, in particular, resin matrix. The wheel rim 40 also includes two opposing faces 42 on which two brake pads (not shown) engage respectively when brake is applied. However, a problem with this wheel rim 40 is that movement of the brake pads on the faces 42 creates shear forces in accordance with X-axis as well as generates heat and the heat will dissolve the resin matrix between the layers 41 and the shear forces can cause detachment between the layers 41.

As another example, a section of a known tubular type composite carbon fiber wheel rim 50 is shown in FIG. 10. The wheel rim 50 includes layers of carbon fiber 51 being stacked with one another in accordance with Y-axis by resin. The wheel rim 50 also includes two opposing faces 52 on which two brake pads (not shown) engage respectively when brake is applied. Again, the wheel rim 50 suffers the same problem in which movement of the brake pads on the faces 52 creates shear forces in accordance with X-axis as well as generates heat and the heat will dissolve the resin matrix between the layers 51 and the shear forces can cause detachment between the layers 51.

Taiwan Patent No.540478, which teaches improved structure for composite material wheel rim of bicycle, shows a wheel rim with a low heat conduction, fast heat dissipation and wear-resisting aluminum region to prevent brake pads in direct contact with the wheel rim. However, such an aluminum region can gradually wears out the brake pads.

The present invention is, therefore, intended to obviate or at least alleviate the problems encountered in the prior art.

### SUMMARY OF THE INVENTION

It is therefore an object of the present invention to provide a tubular type composite carbon fiber wheel rim and the method of making, which overcomes the hereinbefore mentioned problems.

It is also an object of the present invention to provide a clincher type composite carbon fiber wheel rim and the method of making

Accordingly, a tubular type composite carbon fiber wheel rim includes a friction-resisting rim body having an inner and outer circumferential periphery, and an inner rim body being disposed along the inner circumferential periphery of the friction-resisting rim body. A method for making such a wheel rim comprises forming a friction-resisting rim body, mounting an inner rim body to the friction-resisting rim body, and making the friction-resisting rim body and the inner rim body as an integral piece.

Accordingly, a clincher type composite carbon fiber wheel rim further comprises an outer rim disposed along the outer circumferential periphery in view of the tubular type composite carbon fiber wheel rim. The outer rim is mounted to the friction-resisting rim body while mounting the inner rim.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a process flow chart of making a wheel rim in accordance with the present invention.

FIG. 2 is a perspective view of a wheel rim in accordance with the present invention.

FIG. 3 is an exploded perspective view of the wheel rim of FIG. 2.

FIG. 4 is a process flow chart of making a friction-resisting rim body of the wheel rim.

FIG. 5 is a perspective view showing arrangement of carbon fibers in the friction-resisting rim body.

FIG. 6 is a perspective cutout view of the friction-resisting rim body.

FIG. 7 is a perspective cutout and exploded view of the wheel rim of FIG. 2.

FIG. 8 is a perspective cutout view of the wheel rim of FIG. 2.

FIG. 9 is a perspective cutout view of a conventional wheel rim.

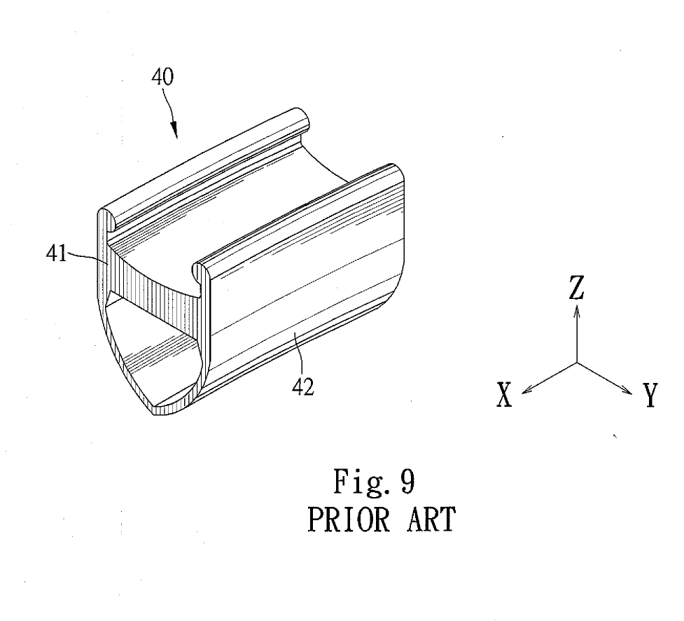

FIG. 10 is a perspective cutout view of another conventional wheel rim.

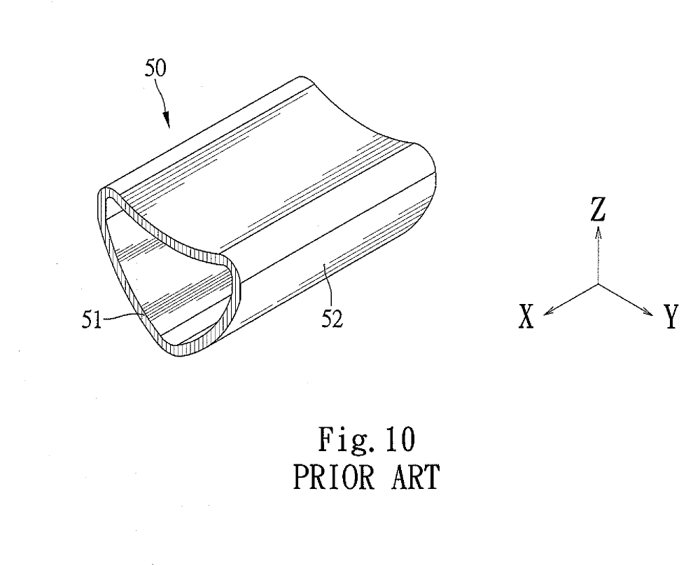

### DETAILED DESCRIPTION OF THE PREFERRED EMBODIMENT

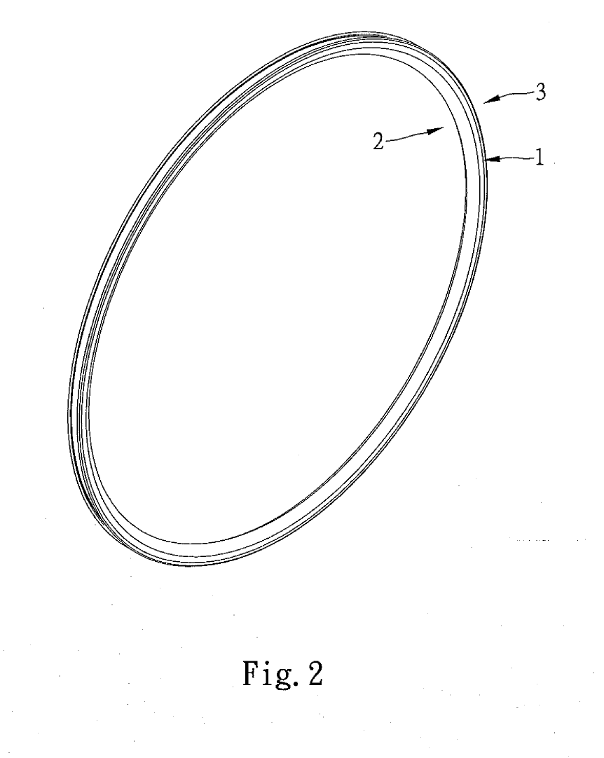

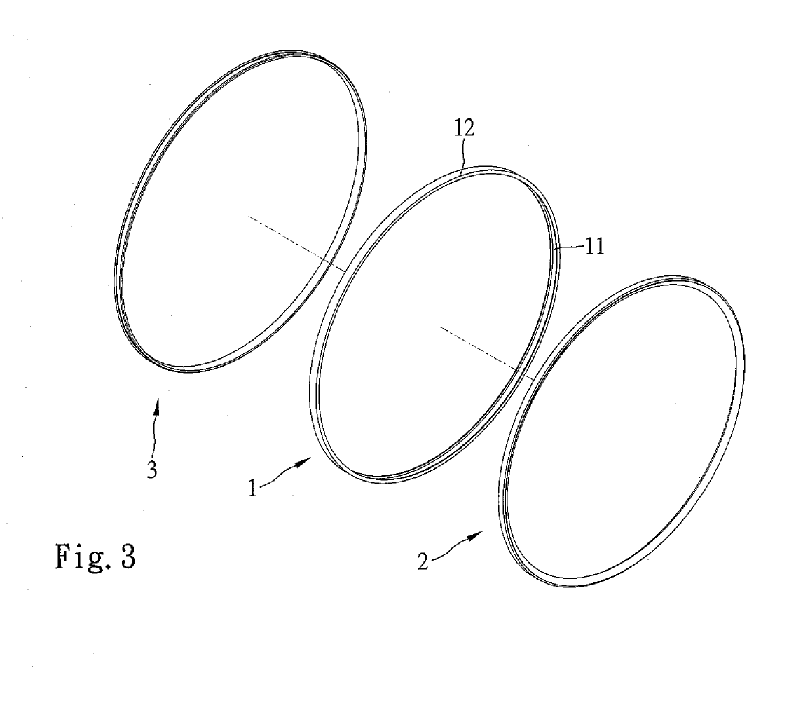

Referring to FIGS. 2 and 3, a wheel rim in accordance with the present invention comprise three separate rims, namely a friction-resisting rim body 1, an inner rim body 2 and an outer rim body 3. The friction-resisting rim body 1 has a circumferential periphery defining an inner circumferential periphery 11 with a radius and an outer circumferential periphery 12 with a radius larger than that of the inner circumferential periphery 11. Also, both the inner and outer circumferential peripheries 11 and 12 define a recess respectively. Preferably, the recess of the outer circumferential periphery 12 is arcuate. Furthermore, the inner circumferential periphery 11 along which the inner rim body 2 can be disposed, and the outer circumferential periphery 12 along which the outer rim body 3 can be disposed.

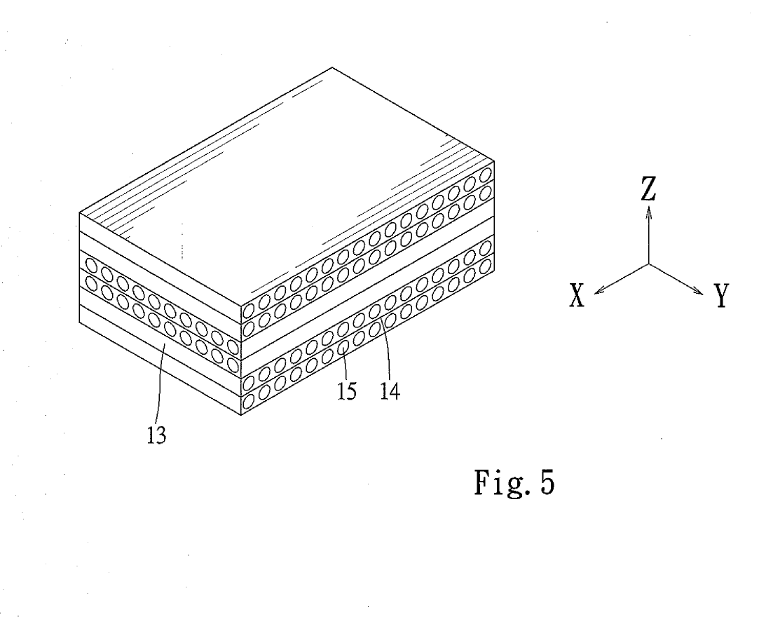

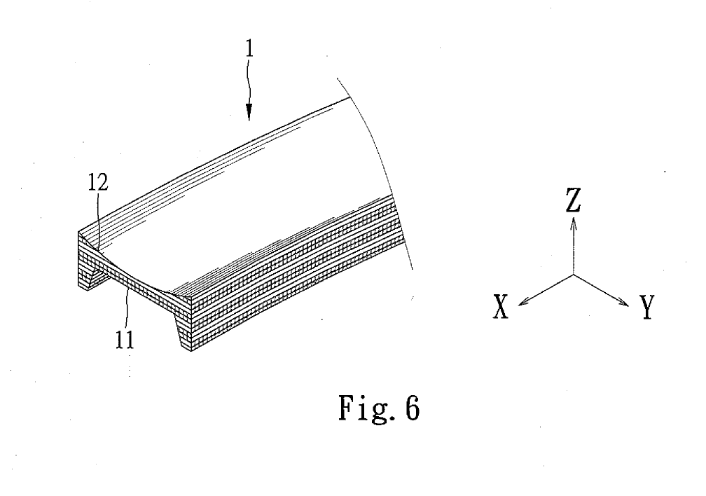

Referring to FIGS. 5 and 6, the friction-resisting rim body 1 includes a plurality of layers of reinforced fibers 13. Preferably, these layers of reinforced fibers 13 are made by carbonization process at above 1800° Celsius. By undergoing this process, the layers of reinforced fibers 13 are found to have relatively high strength and are resistant to effects of high temperature. The plurality of layers 13 are being bounded with one another in accordance with Z-axis by resin matrix 14. Furthermore, each layer 13 includes a plurality of carbon fiber yarns 15 arranged in an array and some layers 13 have their carbon fiber yarns 15 extending in accordance with X-axis (i.e. the direction in which the circumferential periphery of the wheel rim extends) and some layers 13 have their carbon fiber yarns 15 extending in accordance with Y-axis (i.e. the direction in which the thickness of the wheel rim extends).

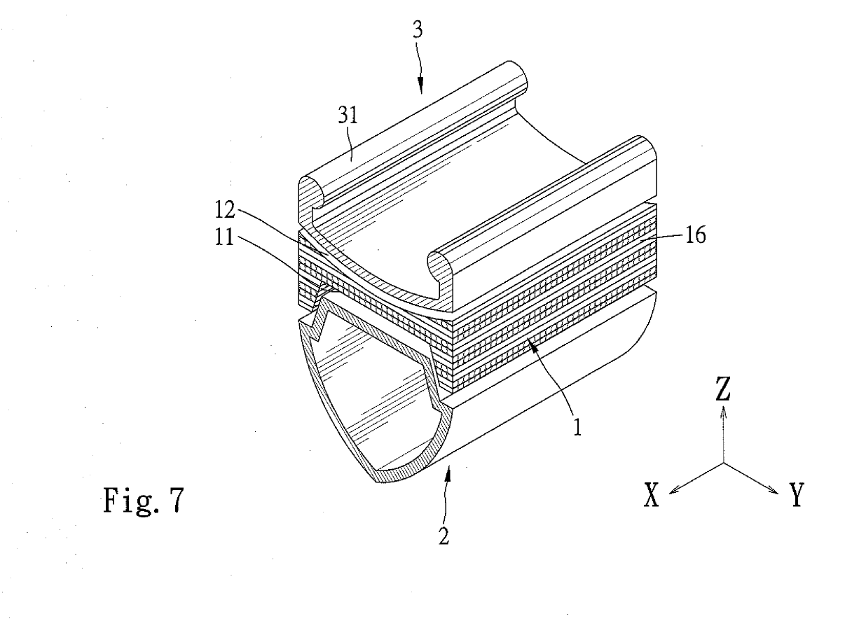

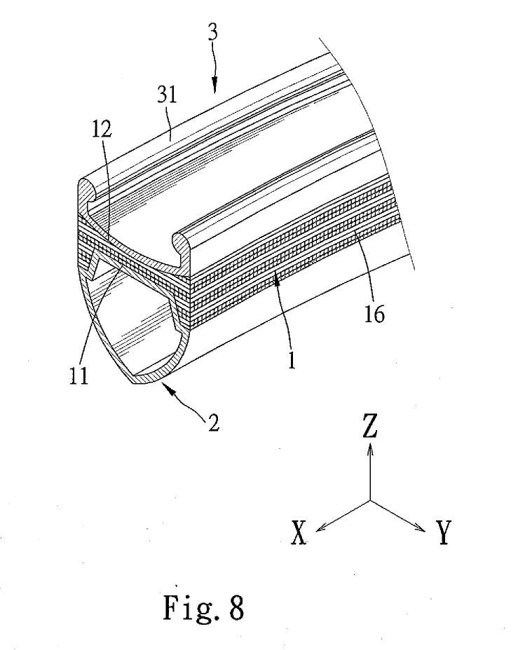

Referring to FIGS. 7 and 8, the friction-resisting rim body 1 defines two opposing faces 16. The faces 16 are being spaced at a distance determining the thickness of the wheel rim and each face 16 can be engaged by a brake pad (not shown) when the brake is applied.

Still referring to FIGS. 7 and 8, the inner rim body 2 takes the form of a tube rather than a solid structure, and as such, the weight of the wheel rim can be reduced. Furthermore, the inner rim body 2 can include layers of carbon fiber being stacked with one another.

The outer rim body 3 includes two holding portions 31. In this embodiment, the holding portions 31 are adapted to securely hold a tire or a tubeless tire. Furthermore, the outer rim body 3 can include layers of carbon fiber being stacked with one another.

In this embodiment, layers 13 will not suffer from detachment therebetween when brake is applied, because layers 13 are being stacked in a direction that minimize contact area of each layer 13 with brake pads. Also, layers 13 with their carbon fiber yarns 15 extending in accordance with Y-axis and layers 13 with their carbon fiber yarns 15 extending in accordance with Y-axis are being alternatively stacked. As a result, detachment between layers can further be prevented. Also, the phenomenon in this embodiment when brake is applied is that layers 13 with their carbon fiber yarns 15 in accordance with Y-axis will not suffer from detachment by this movement, nevertheless, the lengths of carbon fiber yarns 15 can become shortened by this movement. Layers 13 whose carbon fiber yarns 15 extending in accordance with X-axis serve to enable brake action to be smooth.

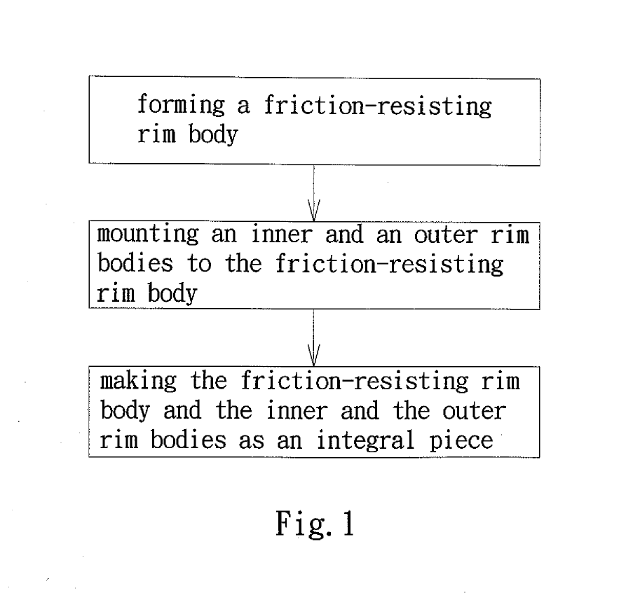

Referring now to FIG. 1 for a method of making such a wheel rim of the present invention, the method comprises forming a friction-resisting rim body 1 as a first step; mounting an inner and an outer rim bodies 2 and 3 to the friction-resisting rim body 1 as a second step; making the friction-resisting rim body 1 and the inner and the outer rim bodies 2 and 3 as an integral piece as a last step.

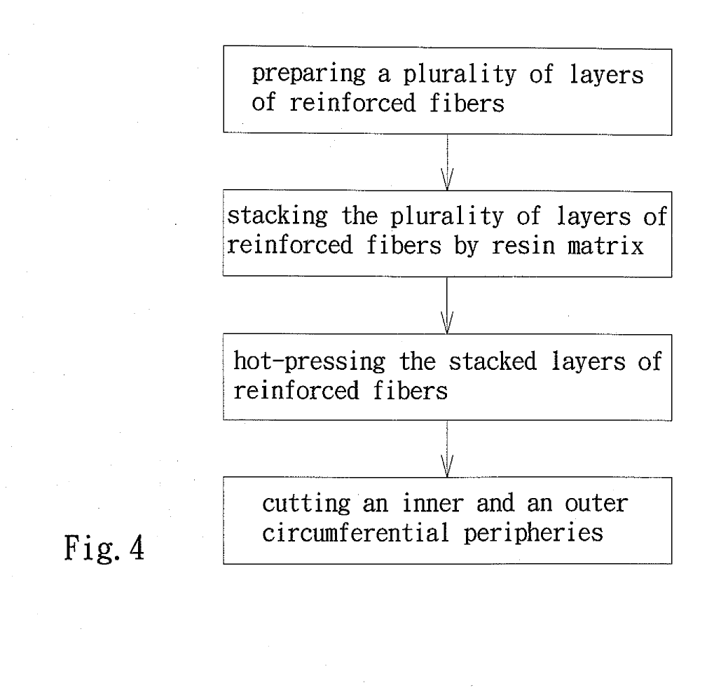

FIG. 4 shows a method of making the friction-resisting rim body 1, the method comprises preparing a plurality of layers of reinforced fibers 13 made by carbonization process at above 1800° Celsius as a first step; then stacking the plurality of layers 13 by resin matrix 14; then hot-pressing the stacked layers 13; and finally cutting an inner and an outer circumferential peripheries 11 and 12.

FIG. 5 shows the plurality of layers 13 stacked with one another in accordance with Z-axis and with some layers 13 having their carbon fiber yarns 15 extending in accordance with X-axis (i.e. the direction in which the circumferential periphery of the wheel rim extends) and with some layers 13 having their carbon fiber yarns 15 extending in accordance with Y-axis (i.e. the direction in which the thickness of the wheel rim extends).

During hot-pressing, the resin matrix 14 can get molten and flow out of the stacked layers 13 such that the remained resin matrix 14 for the stacked layers 13 is reduced to 35%-40% before becoming hardened. Additionally, the liquidized resin matrix 14 can bring any evaporated matter out of the stacked layers 13, thus resulting in disappearance of voids in the stacked layers 13.

FIGS. 3 and 6 show that the inner and outer circumferential peripheries 11 and 12 are being cut along a circumferential periphery of the friction-resisting rim body 1. The inner circumferential periphery 11 is adapted to circumferentially receive the inner rim body 2 while the outer circumferential periphery 12 is adapted to circumferentially receive the outer rim body 3, as seen in FIG. 8. Preferably, the inner circumferential periphery 11 is recess-shaped, and the outer circumferential periphery 12 is arcuate recess-shaped. Also, the inner rim body 2 takes the form of a tube for weight-saving purpose and is adapted to be connectable to high-tensioned bike spokes, while the outer rim body 3 includes two holding portions 31 adapted to securely hold a tire or a tubeless tire.

Since the inner and outer rim bodies 2 and 3 are made by using a conventional technique, such as that described in the Description of the Related Art, therefore, the skill will not be further described herein.

Also, though it is not shown, the wheel rim can be made without engaging with the outer rim body 3. In this regard, the wheel rim is categorized as a tubular type.

While the specific embodiments have been illustrated and described, numerous modifications come to mind without significantly departing from the spirit of invention and the scope of invention is only limited by the scope of accompanying claims.

What is claimed is:

1. A composite carbon fiber wheel rim of a tubular type comprising:
a friction-resisting rim body having an inner and outer circumferential periphery; and
an inner rim body, which takes the form of a tube, being disposed along the inner circumferential periphery of the friction-resisting rim body.

2. A composite carbon fiber wheel rim of a clincher type comprising:
a friction-resisting rim body having an inner and outer circumferential periphery;
an inner rim body, which takes the form of a tube, being disposed along the inner circumferential periphery of the friction-resisting rim body; and
an outer rim body being disposed along the outer circumferential periphery of the friction-resisting rim body.

3. The wheel rim as claimed in claim 1 wherein the friction-resisting rim body comprises a plurality of layers of reinforced fibers being stacked with one another, with each layer comprising a plurality of carbon fiber yarns in an array, and wherein the plurality of layers of reinforced fibers comprises a first group of layers and a second group of layers, with the first group of layers having their plurality of carbon yarns extending in a first direction, with the second group of layers having their plurality of carbon yarns extending in a second direction, and with first direction being perpendicular to the second direction.

4. The wheel rim as claimed in claim 2 wherein the friction-resisting rim body comprises a plurality of layers of reinforced fibers being stacked with one another, with each layer comprising a plurality of carbon fiber yarns in an array, and wherein the plurality of layers of reinforced fibers comprises a first group of layers and a second group of layers, with the first group of layers having their plurality of carbon yarns extending in a first direction, with the second group of layers having their plurality of carbon yarns extending in a second direction, and with first direction being perpendicular to the second direction.

5. The wheel rim as claimed in claim 3 wherein the plurality of layers of reinforced fiber are secured by resin matrix.

6. The wheel rim as claimed in claim 4 wherein the plurality of layers of reinforced fiber are secured by resin matrix.

7. A method for making a composite carbon fiber wheel rim of a clincher type comprising:
forming a friction-resisting rim body as a first step;
mounting an inner and an outer rim bodies to the friction-resisting rim body as a second step; and
making the friction-resisting rim body and the inner and outer rim bodies as an integral piece as a last step; and wherein
a method for making a friction-resisting rim body comprising;
preparing a plurality of layers of reinforced fibers made by carbonization process at above 1800° Celsius as a first step;
stacking the plurality of layers by resin matrix as a second step;
hot-pressing the stacked layers of reinforced fibers as a third step; and
cutting an inner and outer circumferential peripheries as a last step.

8. A method for making a composite carbon fiber wheel rim of a tubular type comprising:
forming a friction-resisting rim body as a first step;
mounting an inner rim body to the friction-resisting rim body as a second step; and
making the friction-resisting rim body and the inner rim body as an integral piece as a last step; and wherein
a method for making a friction-resisting rim body comprising;
preparing a plurality of layers of reinforced fibers made by carbonization process at above 1800° Celsius as a first step;
stacking the plurality of layers by resin matrix as a second step;
hot-pressing the stacked layers of reinforced fibers as a third step; and
cutting an inner and an outer circumferential peripheries as a last step.

9. The method as claimed in claim 7 wherein each layer of reinforced carbon fibers comprises a plurality of carbon fiber yarns in an array, and wherein the plurality of layers of reinforced fibers comprises a first group of layers and a second group of layers, with the first group of layers having their plurality of carbon yarns extending in a first direction, with the second group of layers having their plurality of carbon yarns extending in a second direction, and with first direction being perpendicular to the second direction.

10. The method as claimed in claim 8 wherein each layer of reinforced carbon fibers comprises a plurality of carbon fiber yarns in an array, and wherein the plurality of layers of reinforced fibers comprises a first group of layers and a second group of layers, with the first group of layers having their plurality of carbon yarns extending in a first direction, with the second group of layers having their plurality of carbon yarns extending in a second direction, and with first direction being perpendicular to the second direction.

11. The method as claimed in claim 9 wherein the resin matrix can get molten and is flow out of the stacked layers during hot-pressing process, and wherein the remained resin matrix for the stacked layers is reduced to 35%-40% before becoming hardened.

12. The method as claimed in claim 10 wherein the resin matrix can get molten and is flow out of the stacked layers during hot-pressing process, and wherein the remained resin matrix for the stacked layers is reduced to 35%-40% before becoming hardened.

13. The method as claimed in claim 7 wherein the inner and outer circumferential peripheries are cut along a circumferential periphery defined by the friction-resisting rim body.

14. The method as claimed in claim 8 wherein the inner and outer circumferential peripheries are cut along a circumferential periphery defined by the friction-resisting rim body.

15. The method as claimed in claim 13 wherein the inner rim body takes the form of a tube.

16. The method as claimed in claim 14 wherein the inner rim body takes the form of a tube.
